(19) United States
(12) Patent Application Publication
(10) Pub. No.: US 2024/0179250 A1
(43) Pub. Date: May 30, 2024

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventor: Kenji SAWAI, Kanagawa (JP)

(73) Assignee: FUJIFILM Business Innovation Corp., Tokyo (JP)

(21) Appl. No.: 18/318,727

(22) Filed: May 17, 2023

(30) Foreign Application Priority Data
Nov. 24, 2022 (JP) 2022-187631

(51) Int. Cl. H04N 1/00; G06K 15/00

(52) U.S. Cl. CPC H04N 1/00344; G06K 15/40; H04N 1/00076

(57) ABSTRACT

An information processing apparatus includes a processor configured to: specify replacement parts that are installable in an apparatus in place of some of parts constituting the apparatus; and output one or more of information related to a form of the specified replacement part, information related to a weight of the specified replacement part, and information related to installation of the specified replacement part in the apparatus.

### CROSS-REFERENCE TO RELATED APPLICATIONS

This application is based on and claims priority under 35 USC 119 from Japanese Patent Application No. 2022-187631 filed Nov. 24, 2022.

### BACKGROUND

### (i) Technical Field

The present invention relates to an information processing apparatus and a non-transitory computer readable medium storing a program.

### (ii) Related Art

JP5999113B discloses a process that forms a test image on a photoconductor drum, transfers the test image to an intermediate transfer belt, and causes a control unit to determine a portion causing an image defect that occurs in a case in which the image is output, on the basis of a density detection result of the test image by a density detection sensor.

### SUMMARY

In a case in which replacement parts are installed in place of some of parts constituting an apparatus, for example, the transportation of the replacement parts and the temporary storage of the replacement parts may be performed, and then the replacement parts may be installed. Further, in a case in which there are a plurality of candidates for the replacement part, the cost required for replacement or the work time required for replacement changes depending on the replacement part to be selected.

Here, in a configuration in which only information related to a model number of the replacement part is output and a person to be notified is notified of the information, there is a lack of materials for various determinations performed in a case in which replacement with the replacement part is performed, and convenience in a case in which the work of installing the replacement part is performed is likely to be reduced.

Aspects of non-limiting embodiments of the present disclosure relate to an information processing apparatus and a non-transitory computer readable medium storing a program that improve convenience in a case in which some of parts constituting an apparatus are replaced with replacement parts, as compared to a case in which only information related to a model number of the replacement part is output.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: specify replacement parts that are installable in an apparatus in place of some of parts constituting the apparatus; and output one or more of information related to a form of the specified replacement part, information related to a weight of the specified replacement part, and information related to installation of the specified replacement part in the apparatus.

### BRIEF DESCRIPTION OF THE DRAWINGS

Exemplary embodiment(s) of the present invention will be described in detail based on the following figures, wherein:

FIG. 1 is a diagram showing an example of an information processing system;

FIG. 2 is a diagram showing an example of a hardware configuration of a server apparatus and a terminal apparatus;

FIG. 3 is a diagram showing an image forming apparatus;

FIG. 4 is a diagram showing a display screen displayed on a display device of the terminal apparatus;

FIG. 5 is a diagram showing another example of the display screen displayed on the display device of the terminal apparatus;

FIG. 6 is a diagram showing still another example of the display screen displayed on the display device of the terminal apparatus;

FIG. 7 is a diagram showing yet another example of the display screen displayed on the display device of the terminal apparatus;

FIGS. 8A and 8B are diagrams showing a display screen displayed on the terminal apparatus in a case in which priority is received; and

FIGS. 9A and 9B are diagrams showing an example of a display screen after a person to be notified performs an operation of switching the display screen.

### DETAILED DESCRIPTION

Hereinafter, an exemplary embodiment of the invention will be described in detail with reference to the accompanying drawings.

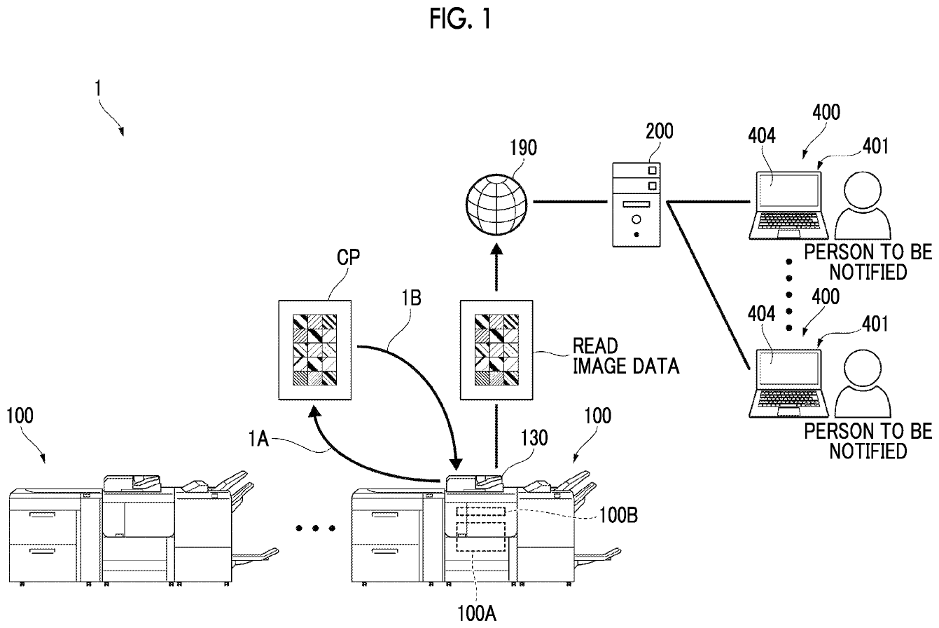

FIG. 1 is a diagram showing an example of an information processing system 1.

The information processing system 1 according to the present exemplary embodiment is provided with a plurality of image forming apparatuses 100 and a server apparatus 200 that is connected to each of the plurality of image forming apparatuses 100 through a communication line 190.

Further, the information processing system 1 is provided with a plurality of terminal apparatuses 400. The plurality of terminal apparatuses 400 are connected to the server apparatus 200 through a communication line (not shown).

In the present exemplary embodiment, a maintainer who maintains the image forming apparatus 100 or a user of the image forming apparatus 100 refers to information displayed on the terminal apparatus 400.

The terminal apparatus 400 is configured by a personal computer (PC), a smartphone, or the like.

Each of the image forming apparatuses 100 is provided with an image forming unit 100A as an example of image forming means that form an image on paper which is an example of a recording medium.

For example, the formation of an image on paper by the image forming unit 100A is performed by an inkjet method or an electrophotographic method.

In addition, the formation of an image on paper by the image forming unit 100A is not limited to the inkjet method or the electrophotographic method, but may be performed by other methods.

In the present exemplary embodiment, the image forming apparatus 100 is diagnosed by the server apparatus 200 which is an example of an information processing apparatus.

Further, in a case in which it is determined that some of parts constituting the image forming apparatus 100 fail or in a case in which it is determined that there is a high possibility that some of the parts constituting the image forming apparatus 100 will fail, a person to be notified is notified of information through the terminal apparatus 400.

Specifically, in the present exemplary embodiment, the person to be notified is notified of information related to a replacement part, which is a part newly mounted on the image forming apparatus 100 instead of the part determined to fail, through the terminal apparatus 400.

Alternatively, in the present exemplary embodiment, the person to be notified is notified of information related to a replacement part, which is a part newly mounted on the image forming apparatus 100 instead of the part determined to have a high possibility of failure, through the terminal apparatus 400.

Specifically, in the present exemplary embodiment, the person to be notified is notified of the information related to the replacement part through a display device 401 that is provided in the terminal apparatus 400.

In addition, hereinafter, in the specification, the part determined to fail and the part determined to have a high possibility of failure are referred to as “failed parts”.

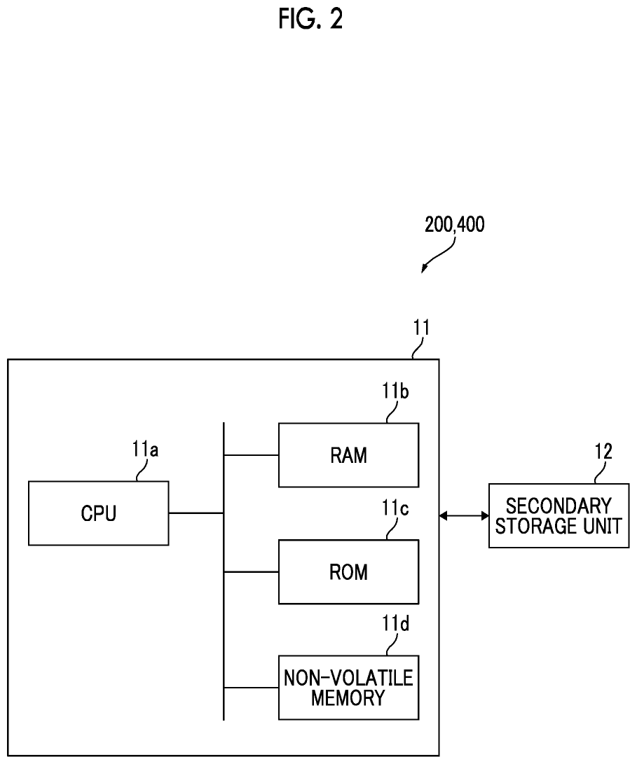

FIG. 2 is a diagram showing an example of a hardware configuration of the server apparatus 200 and the terminal apparatus 400.

The server apparatus 200 and the terminal apparatus 400 are implemented by a computer. Further, the terminal apparatus 400 is provided with the display device 401 shown in FIG. 1 in addition to the configuration shown in FIG. 2, which is not shown in FIG. 2.

As shown in FIG. 2, each of the server apparatus 200 and the terminal apparatus 400 has an arithmetic processing unit 11 that performs digital arithmetic processing according to a program and a secondary storage unit 12 on which a file and the like are recorded.

The secondary storage unit 12 is implemented by an existing information storage device such as a hard disk drive (HDD), a semiconductor memory, or a magnetic tape.

The arithmetic processing unit 11 is provided with a CPU 11a as an example of a processor.

In addition, the arithmetic processing unit 11 is provided with a RAM 11b which is used as a work memory or the like of the CPU 11a and a ROM 11c in which programs or the like executed by the CPU 11a are stored.

Further, the arithmetic processing unit 11 is provided with a non-volatile memory lid that is configured to be rewritable and can hold data even in a case in which power supply is interrupted.

The non-volatile memory 11d is configured by, for example, an SRAM or a flash memory that is backed up by a battery. The secondary storage unit 12 stores the programs executed by the arithmetic processing unit 11 in addition to files and the like.

In the present exemplary embodiment, the CPU 11a provided in the arithmetic processing unit 11 reads the program stored in the ROM 11c or the secondary storage unit 12 to perform each process.

The program executed by the CPU 11a can be provided to the server apparatus 200 and the terminal apparatus 400 in a state in which the program is stored in a computer-readable recording medium such as a magnetic recording medium (for example, a magnet tape or a magnetic disk), an optical recording medium (for example, an optical disk), a magneto-optical recording medium, or a semiconductor memory. Further, the program executed by the CPU 11a may be provided to the server apparatus 200 and the terminal apparatus 400 by communication means such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

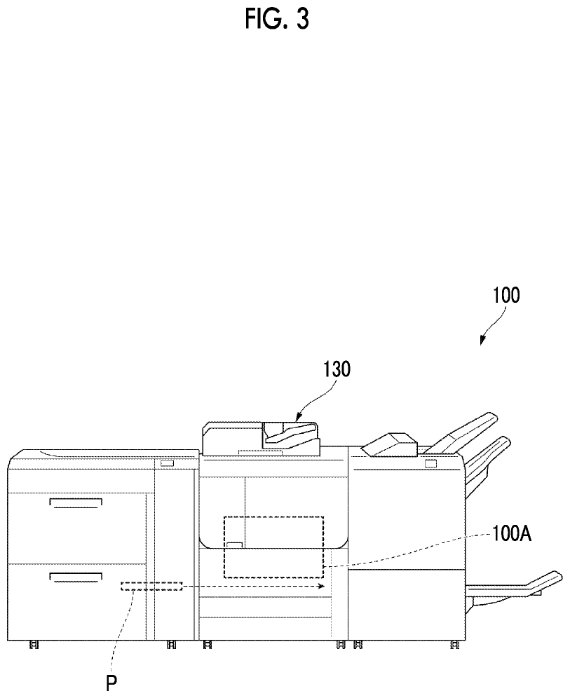

FIG. 3 is a diagram showing the image forming apparatus 100.

Each of the image forming apparatuses 100 is provided with the image forming unit 100A that forms an image on paper P which is an example of the recording medium.

Further, the image forming apparatus 100 is provided with an image reading device 130 as an example of image reading means that read the image formed on the recording medium such as the paper P. The image reading device 130 is a so-called scanner having a function of transporting the paper P.

The image reading device 130 comprises a light source that emits light to the paper P and a light receiving unit, such as a CCD, that receives reflected light from the paper P. In the present exemplary embodiment, read image data is generated on the basis of the reflected light received by the light receiving unit.

The image reading device 130 sequentially reads the paper P set by the user.

In addition, an installation aspect of the image reading device 130 is not limited to this, and the image reading device 130 may be provided inside the image forming apparatus 100 and on a transport path of the paper P.

In a case in which the image reading device 130 is provided inside the image forming apparatus 100 and on the transport path of the paper P, the paper P on which the image has been formed by the image forming unit 100A sequentially passes through the image reading device 130. In a case in which the paper passes, each image on the paper P is sequentially read.

In addition, each of the image forming apparatuses 100 has an information transmission function of transmitting information to the server apparatus 200.

In the present exemplary embodiment, in a case in which the image forming apparatus 100 is diagnosed, first, the image forming unit 100A is operated to form a chart image on the paper P.

Therefore, as represented by reference numeral 1A in FIG. 1, chart paper CP which is the paper P on which a chart image, which is an example of a diagnostic image, has been formed is generated.

The chart image is an image used to diagnose the image forming unit 100A. In the present exemplary embodiment, the chart paper CP which is the paper P on which the chart image used for the diagnosis has been formed is generated.

In a case in which the chart paper CP is generated, the image reading device 130 is used to read the chart image on the chart paper CP as represented by reference numeral 1B in FIG. 1.

Therefore, the read image data obtained by reading the chart paper CP is generated.

Then, in the present exemplary embodiment, the read image data is transmitted to the server apparatus 200.

The server apparatus 200 diagnoses the image forming apparatus 100 that has obtained the read image data on the basis of the read image data.

Further, in a case in which the server apparatus 200 determines that some of the parts constituting the image forming apparatus 100 fail or that there is a high possibility that some of the parts constituting the image forming apparatus 100 will fail, the server apparatus 200 notifies the person to be notified of information through the display device 401 provided in the terminal apparatus 400.

Specifically, the server apparatus 200 notifies the person to be notified of information related to a replacement part that replaces the failed part or of information related to a replacement part that replaces the part having a high possibility of failure through the terminal apparatus 400.

Specifically, the server apparatus 200 outputs, to the terminal apparatus 400, the information related to the replacement part that replaces the failed part or the information related to the replacement part that replaces the part having a high possibility of failure.

Therefore, the information related to the replacement part is displayed on the display device 401 provided in the terminal apparatus 400 such that the person to be notified is notified of the information related to the replacement part that replaces the failed part or the information related to the replacement part that replaces the part having a high possibility of failure.

The server apparatus 200 stores the information related to the replacement parts and information related to priorities (which will be described in detail below) set by the user of the image forming apparatus 100, and the CPU 11a of the server apparatus 200 outputs the information related to the replacement parts on the basis of the above-described information.

Specifically, in the present exemplary embodiment, for each of the parts constituting the image forming apparatus 100, a replacement part that is newly installed in the image forming apparatus 100 in place of the part is associated with the part. The information related to the parts constituting the image forming apparatus 100 and the information related to the replacement parts are stored in the server apparatus 200 in association with each other.

In the output of the information related to the replacement parts, the CPU 11a of the server apparatus 200 acquires and outputs the information related to the replacement parts with reference to this information stored in the server apparatus 200.

Here, the CPU 11a which is provided as an example of the processor in the server apparatus 200 specifies a failed part or a part having a high possibility of failure for each of the image forming apparatus 100 on the basis of the read image data as described above.

Then, the CPU 11a specifies the replacement parts which are parts replacing these parts. In other words, the CPU 11a specifies the replacement parts which are parts that can be installed in the image forming apparatus 100 in place of some of the parts constituting the image forming apparatus 100. Then, the CPU 11a outputs information related to the specified replacement parts to the terminal apparatus 400.

Therefore, the information related to the replacement parts is displayed on the display device 401 provided in the terminal apparatus 400. Then, the person to be notified obtains the information related to the replacement parts.

An example of the person to be notified is a person who belongs to a manufacturing company that has manufactured the image forming apparatus 100 and whose job is to maintain the image forming apparatus 100. In addition, another example of the person to be notified is a person who is given a commission to maintain the image forming apparatus 100 from a manufacturing company that manufactures the image forming apparatus 100.

Further, still another example of the person to be notified is a user who uses the image forming apparatus 100.

Here, it is assumed that the maintainer who maintains the image forming apparatus 100 moves to each of installation locations where the image forming apparatuses 100 are installed and performs a maintenance operation.

In this case, as a larger amount of information related to the replacement parts is obtained, a determination regarding the transportation of the replacement parts to each of the installation locations can be made more accurately.

An example of the information related to the replacement part is a model number of the replacement part. However, in a configuration in which the person to be notified is notified of only the model number, it is difficult to make a determination regarding the transportation of the replacement part.

On the other hand, in the present exemplary embodiment, the person to be notified is notified of information other than the model number. Therefore, the person to be notified can make a more accurate determination regarding the transportation of the replacement parts to each of the installation locations.

In addition, it is assumed that the person to be notified is a user who uses the image forming apparatus 100 and the user orders the replacement parts.

In this case, in a configuration in which the user is notified of only the information of, for example, the model number of the replacement part, the convenience of the user is likely to be reduced.

Here, it is also assumed that the user stores the ordered replacement part in a living room or the like. In a case in which, for example, the size of the replacement part is known, the user determines whether or not the replacement part can be stored in the living room or the like.

In this case, in a configuration in which the user is notified of only the information related to the model number of the replacement part, it is not determined whether or not the replacement part can be stored in the living room or the like, and the convenience of the user is reduced.

Further, there are some maintainers and users who want to know the work time required for replacing the failed part with the replacement part.

In this case, as described above, in the configuration in which the person to be notified is notified of only the model number of the replacement part through the terminal apparatus 400, the request of the maintainer or the user who wants to know the work time is not satisfied.

Therefore, in a case in which the information related to the replacement part is output, the CPU 11a according to the present exemplary embodiment outputs information other than the model number of the replacement part. In addition, the output of the information related to the model number of the replacement part is not excluded, and information other than the model number may be output together with the information related to the model number of the replacement part.

Further, in the present exemplary embodiment, as described above, for example, a replacement part is specified in a case in which there is a failed part that fails actually or a failed part that has a high possibility of failure.

However, the specification of the replacement part is not limited thereto. For example, a part that is predicted to fail in the future may be specified on the basis of the read image data, and a part that replaces the specified part may be specified as the replacement part.

### Specific Example of Information to be Output

In a case in which the information related to the replacement part is output, the CPU 11a of the server apparatus 200 outputs, for example, information related to the weight of the specified replacement part. Specifically, the CPU 11a outputs, for example, information related to the mass of the replacement part which is an example of the information related to the weight of the replacement part.

In the present exemplary embodiment, the information related to the mass of the replacement part is associated with each of the replacement parts, and information for specifying the replacement part and the information related to the mass of the replacement part are stored in the secondary storage unit 12 (see FIG. 2) of the server apparatus 200 in association with each other.

The CPU 11a acquires the information related to the mass of the replacement part with reference to the information stored in the secondary storage unit 12 and outputs the acquired information.

Therefore, in the present exemplary embodiment, the information related to the mass is output to the terminal apparatus 400 (see FIG. 1). The information related to the mass is displayed on the display device 401 provided in the terminal apparatus 400.

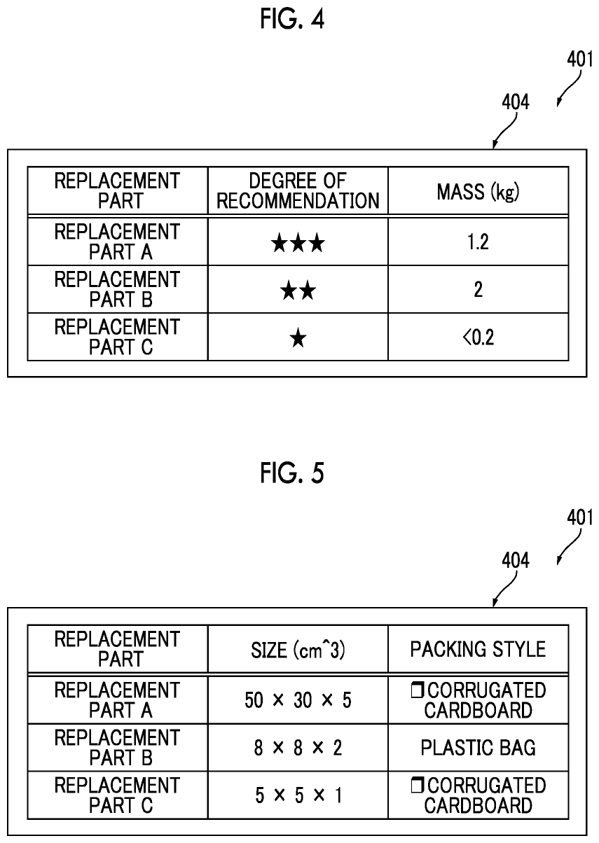

FIG. 4 is a diagram showing a display screen 404 that is displayed on the display device 401 of the terminal apparatus 400.

On the display screen 404 shown in FIG. 4, three replacement parts are specified as candidates for the replacement part, and information related to the mass of each of the three replacement parts is displayed.

Further, in this display example, information related to a degree of recommendation of each of the three replacement parts is displayed.

Here, the degree of recommendation is determined in advance in consideration of factors, such as weight, price, and maintainability, and is stored in the secondary storage unit 12 of the server apparatus 200 in association with each of the replacement parts.

In this display example shown in FIG. 4, the information related to the degree of recommendation is also output to the terminal apparatus 400 and displayed on the display device 401 of the terminal apparatus 400.

The person to be notified can understand the mass or the degree of recommendation of each of the replacement parts with reference to the display screen 404 shown in FIG. 4.

In addition, in a case in which the information related to the replacement part is output, the CPU 11a outputs, for example, information related to the size or packing style of the replacement part.

In a case in which this process is performed, the information for specifying each of the replacement parts and the information related to the size or packing style of each of the replacement parts are stored in advance in the secondary storage unit 12 of the server apparatus 200 in association with each other.

Then, in this case, the CPU 11a acquires the information related to the size or packing style of each of the replacement parts with reference to the information stored in the secondary storage unit 12 and outputs the information.

Therefore, in the present exemplary embodiment, the information related to the size or the information related to the packing style is displayed on the display device 401 of the terminal apparatus 400.

FIG. 5 is a diagram showing another example of the display screen 404 displayed on the display device 401 of the terminal apparatus 400.

Even in this display example shown in FIG. 5, three replacement parts are displayed as candidates for the replacement part, and information related to the form of each of the three replacement parts is displayed. In this display example, the CPU 11a outputs information related to the form of the specified replacement part. In accordance with this, the information related to the form of the replacement part is displayed.

In the present exemplary embodiment, the CPU 11a outputs information related to the size and information related to the packing style as an example of the information related to the form of each of the three replacement parts, and the information is displayed on the display screen 404.

Here, the type of information related to the size is not particularly limited. In the example shown in FIG. 5, a case in which the CPU 11a outputs information related to the dimensions of each of three sides of a length, a width, and a height is given as an example, and the information related to the dimensions is displayed as the information related to the size on the display screen 404.

In addition, as the information related to the size, information that schematically describes the size, such as “large”, “medium”, and “small”, may be displayed.

Further, in the display example shown in FIG. 5, the CPU 11a outputs information related to an exterior material covering the replacement part as the information related to the packing style, and the information related to the exterior material is also displayed on the display screen 404.

Specifically, in this example, for replacement parts A and C, information indicating that the exterior material covering the replacement parts is corrugated cardboard is displayed. For a replacement part B, information indicating that the exterior material covering the replacement part is a plastic bag is displayed.

In this example, the CPU 11a outputs information indicating whether the exterior material has a bag shape or a box shape as the information related to the exterior material. In the display example shown in FIG. 5, information indicating whether the exterior material covering the replacement part is a box-shaped exterior material or a bag-shaped exterior material is displayed.

In addition, in a case in which the information related to the replacement part is output, the CPU 11a outputs, for example, information related to ease of the transportation of the replacement part.

Further, in a case in which the information related to the replacement part is output, the CPU 11a outputs information related to the work time required for replacement. In other words, the CPU 11a outputs information related to the work time required for installing the replacement part in the image forming apparatus 100.

In a case in which this process is performed, the information for specifying the replacement part and the information related to the ease of transportation or the information related to the work time required for replacement are stored in advance in the secondary storage unit 12 of the server apparatus 200 in association with each other.

Then, the CPU 11a acquires the information related to the ease of transportation or the information related to the work time required for replacement for each of the replacement parts with reference to the information stored in the secondary storage unit 12 of the server apparatus 200 and outputs the information.

Therefore, the information related to the ease of the transportation or the information related to the work time required for replacement is output to the terminal apparatus 400. The information is displayed on the display device 401 of the terminal apparatus 400.

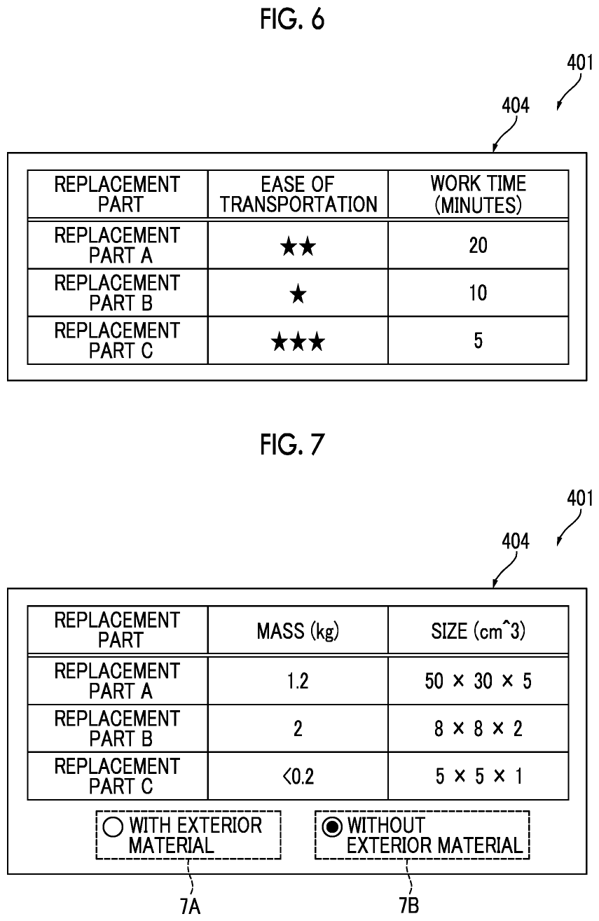

FIG. 6 is a diagram showing still another example of the display screen 404 displayed on the display device 401 of the terminal apparatus 400.

Even in this display example shown in FIG. 6, three replacement parts are specified as candidates for the replacement part, and information related to the installation of each of the three replacement parts in the image forming apparatus 100 is displayed.

In this display example, the CPU 11a outputs the information related to the installation of the replacement parts in the image forming apparatus 100, and the information related to the installation is displayed on the display device 401 of the terminal apparatus 400.

Specifically, in this display example, the CPU 11a outputs, as the information related to the installation of the replacement part, the information related to the ease of the transportation of the replacement part to the image forming apparatus 100 and the information related to the work time required for installing the replacement part in the image forming apparatus 100, and the information is displayed on the display screen 404.

Here, the work time required for installing the replacement part in the image forming apparatus 100 can be said to be the work time required for replacing the failed part with the replacement part.

Here, the ease of the transportation is set in advance on the basis of, for example, the size and weight of the replacement part.

In a case in which the size of the replacement part is greater than a first threshold value predetermined for the size (hereinafter, referred to as a “first size threshold value”) and the weight of the replacement part is greater than a first threshold value predetermined for the weight (hereinafter, referred to as a “first weight threshold value”), information indicating that it is difficult to transport the replacement part is associated with the replacement part.

Further, in a case in which the size of the replacement part is less than a second threshold value predetermined for the size (hereinafter, referred to as a “second size threshold value”) (<the first size threshold value) and the weight of the replacement part is less than a second threshold value predetermined for the weight (hereinafter, referred to as a “second weight threshold value”) (<the first weight threshold value), information indicating that it is easy to transport the replacement part is associated with the replacement part.

Furthermore, in a case in which at least one of two conditions of a first condition in which the size of the replacement part is less than the first size threshold value and is greater than the second size threshold value or a second condition in which the weight of the replacement part is greater than the first weight threshold value and is less than the second weight threshold value is satisfied, information indicating that the ease of the transportation of the replacement part is normal is associated with the replacement part.

In the present exemplary embodiment, as illustrated in FIG. 6, the information related to the ease of the transportation is displayed for each of the replacement parts.

Further, in the display example shown in FIG. 6, the information related to the work time required for replacement is displayed for each of the replacement parts.

In the present exemplary embodiment, the following case has been described: as shown in FIGS. 4 to 6, in a case in which information is displayed on the display device 401 of the terminal apparatus 400, the CPU 11a outputs one of the form information which is information related to the form of the specified replacement part, the weight information which is information related to the weight of the specified replacement part, and the installation information which is information related to the installation of the specified replacement part in the image forming apparatus 100, and the one information item is displayed on one display screen 404.

However, the present disclosure is not limited to this process. In a case in which information is displayed on the display device 401 of the terminal apparatus 400, the CPU 11a may output two or more of the three information items, and the two or more information items may be displayed on one display screen 404.

FIG. 7 is a diagram showing yet another example of the display screen 404 displayed on the display device 401 of the terminal apparatus 400.

In this display example, similarly to the above, three replacement parts are specified as candidates for replacement part and then displayed.

Further, in this display example, information related to the mass and information related to the size are displayed for each of the three replacement parts.

Here, in this display example, the information related to the mass and the information related to the size are information in a case in which the exterior material is not included.

In the display example shown in FIG. 7, a case in which the user wants to display information related to the replacement part that does not include the exterior material is given as an example. In other words, in the display example shown in FIG. 7, a case in which the user wants to display information related to the replacement part that is not covered with the exterior material is given as an example.

In this display example shown in FIG. 7, for each of three replacement parts, information related to the mass and size of the replacement part that is not covered with the exterior material is displayed.

In this display shown in FIG. 7, the CPU 11a outputs information related to a specified replacement part that is not covered with the exterior material.

Therefore, in this display example shown in FIG. 7, for each of three replacement parts, the information related to the replacement part that is not covered with the exterior material is displayed.

In the present exemplary embodiment, as the information related to the replacement parts, both information in a case in which the exterior material is not included and information in a case in which the exterior material is included are displayed.

In the display example shown in FIG. 7, a case in which the user issues an instruction to display the information in a case in which the exterior material is not included is given as an example. In this case, as described above, information related to the mass and size of the replacement part that is not covered with the exterior material is displayed.

In a case in which the user selects a portion represented by reference numeral 7A to issue an instruction to display the information in a case in which the exterior material is included, display on the display screen 404 is switched, and the information related to the mass and size of the replacement part that is covered with the exterior material is displayed on the display screen 404.

Specifically, in a case in which the user selects the portion represented by the reference numeral 7A to issue the instruction to display the information in a case in which the exterior material is included, the information related to the mass and size of the replacement part that is covered with the exterior material is output from the server apparatus 200 to the terminal apparatus 400.

Then, the information related to the mass and size of the replacement part that is covered with the exterior material is displayed on the display device 401 of the terminal apparatus 400.

In a case in which this process is performed, the CPU 11a outputs the information that is related to the specified replacement part and that is related to the replacement part covered with the exterior material. Therefore, for each of the three replacement parts, the information related to the replacement part covered with the exterior material is displayed on the display device 401 of the terminal apparatus 400.

In a case in which the display shown in FIG. 7 is performed, the person to be notified who refers to the terminal apparatus 400 inputs information to the terminal apparatus 400. Specifically, for example, the person to be notified selects the portion represented by the reference numeral 7A or a portion represented by reference numeral 7B to input information to the terminal apparatus 400.

In accordance with this, in the present exemplary embodiment, the display screen 404 of the display device 401 is switched, and first information, which is information related to the mass and size of the replacement part in a case in which the exterior material is included, and second information, which is information related to the mass and size of the replacement part in a case in which the exterior material is not included, are displayed on the display screen 404.

Further, a case in which only one of the first information and the second information is selectively displayed has been described here. However, both the first information and the second information may be displayed on one display screen 404.

In addition, in the display examples shown in FIGS. 4 to 7, text information is displayed as the information related to each of the replacement parts. However, for example, an image of the replacement part, such as an illustration of the replacement part or a photograph including the replacement part, may be displayed. In other words, the appearance of the replacement part may be displayed.

In a case in which this process is performed, the CPU 11a outputs the image of the replacement part such as the illustration of the replacement part or the photograph including the replacement part. Therefore, the image of the replacement part is displayed on the display screen 404.

In addition, in the display of the image of the replacement part, in a case in which the images of a plurality of replacement parts are displayed on one display screen 404, for example, it is desired to unify the scales of the replacement parts.

In a case in which there are a plurality of specified replacement parts and the image of each of the plurality of replacement parts is included in one screen and output, the CPU 11a performs a process of unifying the scales of the replacement parts. Therefore, the scales of the plurality of replacement parts are unified on one display screen 404.

### Another Example of Process

Another example of the process will be described.

In another example of the process, the CPU 11a of the server apparatus 200 acquires priority information which is information related to a priority of the user of the image forming apparatus 100.

Then, the CPU 11a specifies the replacement part presented to the person to be notified on the basis of the priority specified by the acquired priority information.

In other words, the CPU 11a specifies replacement parts to be newly installed in the image forming apparatus 100 in place of the failed parts, which are some of the parts constituting the image forming apparatus 100, on the basis of the priority.

In the present exemplary embodiment, in a case in which there are a plurality of candidates for the replacement part, the CPU 11a specifies the replacement part whose notification is to be sent to the person to be notified, among the plurality of candidates on the basis of the priority.

In this example of the process, first, the priority of the user of the image forming apparatus 100 is received through the terminal apparatus 400 (see FIG. 1).

Specifically, an image for receiving the priority is displayed on the display screen 404 displayed on the display device 401 provided in the terminal apparatus 400 to receive the user's priority through the display screen 404.

In a case in which the user's priority is received, the priority information, which is information related to the priority, is transmitted to the server apparatus 200, and the server apparatus 200 acquires the priority information.

Then, the server apparatus 200 specifies the replacement part whose notification is to be sent to the person to be notified among the plurality of candidates for the replacement part, on the basis of the read image data and the priority information.

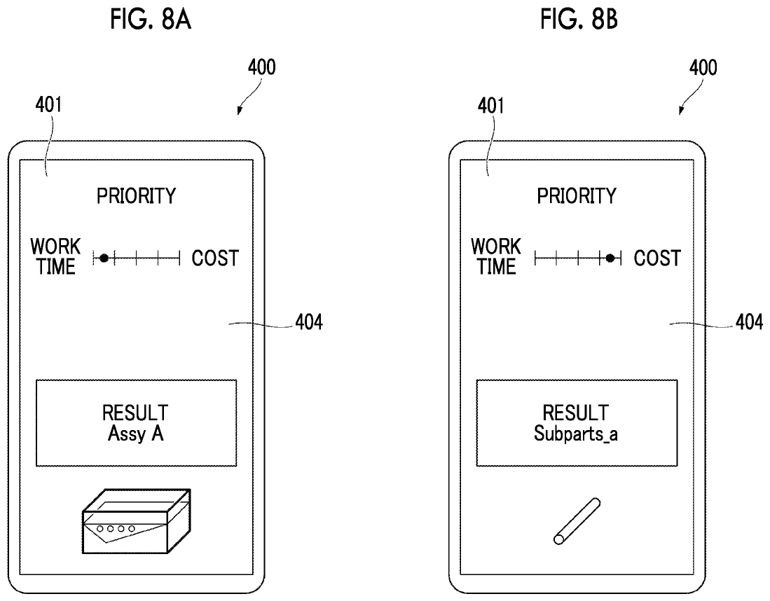

FIGS. 8A and 8B are diagrams showing the display of the display screen 404 on the terminal apparatus 400 in a case in which the priority is received. The display screen 404 is displayed on the display device 401 of the terminal apparatus 400.

Here, examples of the priority include work time and a cost.

In the present exemplary embodiment, information indicating which of the work time and the cost is prioritized or information indicating the priority ratio of the work time to the cost is acquired from the user of the image forming apparatus 100 through the display screens 404 shown in FIGS. 8A and 8B.

The display screen 404 shown in FIGS. 8A and 8B is configured such that the user of the image forming apparatus 100 can select the priority in a stepless manner. In addition, a plurality of steps may be set such that the user can select the priority at each step.

In addition, a configuration may be used in which only one priority is selected from a plurality of priorities.

In a case in which, for example, the CPU 11a acquires, as the priority information, information indicating that the cost is prioritized or information indicating that the priority of the cost is higher than the priority of the work time, the CPU 11a specifies a replacement part that has the same model number as the failed part or a replacement part that has a model number similar to the model number of the failed part.

In other words, in a case in which the CPU 11a acquires the information indicating that the cost is prioritized or the information indicating that the priority of the cost is higher than the priority of the work time, the CPU 11a specifies, as the replacement part, a functional part that fulfills the functions of the failed part instead of an assembly which will be described below. Specifically, for example, the CPU 11a specifies, as the replacement part, a functional part that fulfills the functions of the failed part and that satisfies a predetermined price condition such as the lowest price.

In addition, hereinafter, in the present specification, the above-described functional part that fulfills the functions of the failed part and can be specified as the replacement part may be referred to as an “identical functional part”.

On the other hand, for example, in a case in which the CPU 11a acquires, as the priority information, the information indicating that the work time is prioritized or the information indicating that the priority of the work time is higher than the priority of the cost, the CPU 11a specifies, as the replacement part, a replacement part that is replaced on a unit basis instead of a part basis and outputs information related to this replacement part.

Specifically, in this case, the CPU 11a specifies, as the replacement part, a part consisting of an assembly that has been assembled from a plurality of parts including the above-mentioned identical functional part and parts other than the identical functional part and outputs information related to this assembly.

Therefore, the person to be notified is notified of the information related to the assembly.

Here, the assembly is not particularly limited.

An example of the assembly is a belt unit that has a belt which is circulated and moved and a support roll which supports the belt from the inside and that holds a formed image.

In addition, another example of the assembly is a fixing unit that holds the paper P from both sides and pressurizes the paper P to fix the image formed on the paper P to the paper P.

Further, still another example of the assembly is an image forming unit that comprises a photoconductor drum or the like and forms a toner image on the photoconductor drum.

Furthermore, yet another example of the assembly is a transport unit that comprises a motor and a plurality of roll members which are rotationally driven by the motor and that transports the paper P.

In a case in which the assembly is installed in the image forming apparatus 100 in place of the failed part, the time and effort required for replacement with the replacement part are reduced and the work time required for the replacement is reduced, as compared to a case in which only the identical functional part is installed in place of the failed part.

In a case in which only the identical functional part is installed in place of the failed part, for example, the assembly including the failed part is once taken out to the outside of the image forming apparatus 100, the failed part is removed, and the identical functional part is installed in the assembly.

Then, the assembly having the identical functional part installed therein is returned to the image forming apparatus 100.

On the other hand, in a case in which the assembly is installed in the image forming apparatus 100 in place of the failed part, the assembly including the failed part is removed from the image forming apparatus 100, and a new assembly is installed.

In this case, it is not necessary to remove the failed part from the assembly and to install the identical functional part in the assembly. Therefore, the time and effort required for replacing the failed part with the replacement part are reduced, and the work time required for replacing the failed part with the replacement part is reduced.

In this example of the process, the replacement part whose notification is sent to the person to be notified changes depending on the priority of the user. In the present exemplary embodiment, the information related to the replacement part whose notification is sent to the person to be notified changes depending on the priority of the user.

Here, in a case in which the person to be notified is notified of the assembly as the replacement part, the work time required for replacing the failed part with the replacement part is reduced as described above.

On the other hand, in this case, parts other than the failed part are also replaced, which results in an increase in cost.

Further, in a case in which the person to be notified is notified of the assembly as the replacement part, there is a higher possibility that the failure of the image forming apparatus 100 will be resolved.

Here, in a case in which the person to be notified is notified of the assembly as the replacement part, in addition to the failed part, parts other than the failed part are replaced with new parts.

Here, a case in which the cause of the failure of the image forming apparatus 100 is not clear is also assumed. In this case, a situation in which the failure occurs due to a part that is different from the part determined to be the failed part by the CPU 11a may also occur. In a case in which the person to be notified is notified of the assembly as the replacement part and a new assembly is installed, a plurality of parts are replaced with new parts.

In this case, there is a higher possibility that the failure of the image forming apparatus 100 will be resolved, as compared to a case in which only the failed part is replaced with the replacement part.

On the other hand, in a case in which the person to be notified is notified of the assembly as the replacement part, parts other than the replacement part are also replaced with new parts, which results in an increase in cost of the parts.

Therefore, in the present exemplary embodiment, as described above, the information related to the priority of the user is acquired, and the replacement part whose notification is to be sent to the person to be notified is specified on the basis of the information related to the priority.

Therefore, the user who gives priority to the work time is notified of the assembly as the replacement part, and the user who gives priority to the cost of the parts is notified of the identical functional part as the replacement part.

Here, FIG. 8A shows the display screen 404 in a case in which the user inputs that the work time is prioritized.

Further, FIG. 8A shows a case in which the person to be notified is notified of “Assy A” which is an assembly as the replacement part.

Furthermore, FIG. 8B shows the display screen 404 in a case in which the user inputs that the cost is prioritized.

FIG. 8B further shows a case in which the person to be notified is notified of “subparts_a” which is the identical functional part as the replacement part.

Moreover, in the display examples shown in FIGS. 8A and 8B, a picture or an illustration of the replacement part is displayed such that the person to be notified can understand the size and appearance of the replacement part.

In addition, in a case in which the person to be notified is notified of the assembly or the identical functional part, information related to the weight, the information related to the size, the information related to the packing style, the information related to the ease of transportation, or the information related to the work time required for installing the replacement part may be displayed together with the display screen 404 as in the case shown in FIGS. 4 to 7.

In addition, in the present exemplary embodiment, the person to be notified performs an operation of switching the display screen 404 to display another display screen 404.

Specifically, in the present exemplary embodiment, for example, another display screen 404 is displayed in a case in which the person to be notified selects a button (not shown) for switching the display.

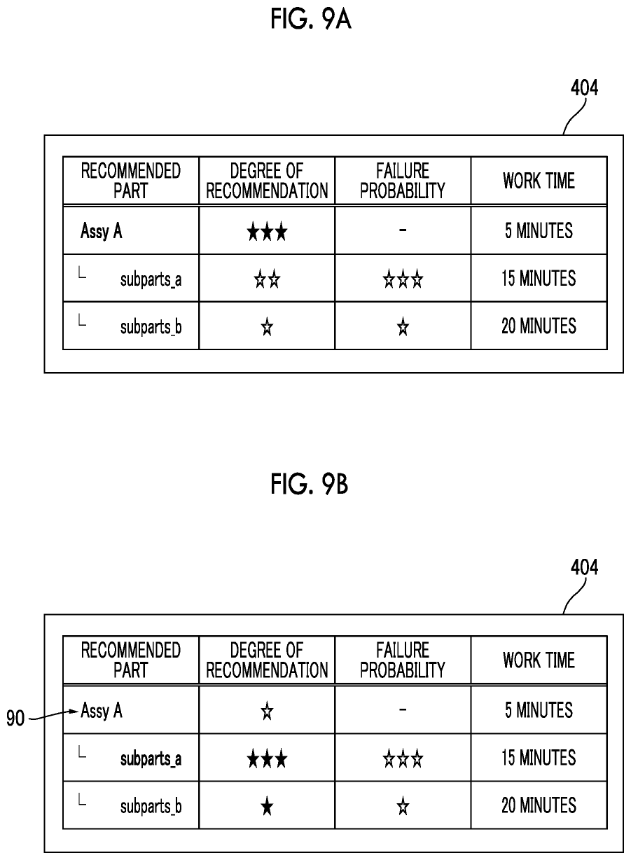

FIGS. 9A and 9B are diagrams showing an example of the display screen 404 after the person to be notified performs the operation of switching the display screen 404.

FIG. 9A shows the display screen 404 displayed in a case in which the work time is prioritized. In this example of the process, the person to be notified is notified of the information related to the assembly in a case in which the work time is prioritized.

In the display example shown in FIG. 9A, in a case in which “Assy A” displayed in bold indicates an assembly and the work time is prioritized, information related to “Assy A” is displayed on the display screen 404.

Further, in the display example shown in FIG. 9A, information related to the degree of recommendation, failure probability, and the work time required for installation is displayed for “Assy A”.

Therefore, the person to be notified knows the information related to “Assy A”.

Further, in the display example shown in FIG. 9A, information related to the parts included in the assembly is displayed, and the person to be notified knows the information related to the parts included in the assembly.

Here, in a case in which the display shown in FIG. 9A is performed and the CPU 11a outputs information related to the specified assembly, the CPU 11a also outputs information related to each of the parts constituting the assembly.

Therefore, the information related to the parts constituting the assembly is also displayed, and the person to be notified knows the information related to the parts included in the assembly.

In this display example, as the information related to the parts included in “Assy A” which is an assembly, information related to “subparts_a” corresponding to the identical functional part and information related to “subparts_b” corresponding to another part different from the identical functional part are displayed.

Further, in this display example, the information related to the degree of recommendation, the failure probability, and the work time is displayed as the information related to “subparts_a”.

Furthermore, in this display example, the information related to the degree of recommendation, the failure probability, and the work time is displayed as the information related to “subparts_b”.

In a case in which the information related to the parts included in the assembly is displayed as shown in FIG. 9A, it is possible to prevent the person to be notified from performing unnecessary work.

In other words, in a case in which the information related to the parts constituting the assembly is displayed as shown in FIG. 9A, it is possible to prevent the person to be notified from performing unnecessary work.

Here, a situation in which it is also necessary to replace “subparts_b” is assumed.

Here, in the display example shown in FIG. 9A, the person to be notified knows that the assembly includes “subparts_b”. In this case, the person to be notified knows that the assembly is replaced to replace “subparts_b”.

In this case, the installation of a new part “subparts_b” separately from the installation of the assembly is suppressed, and the person to be notified is prevented from performing unnecessary work to install the new part “subparts_b” separately from the assembly.

FIG. 9B shows the display screen 404 displayed in a case in which the cost is prioritized.

In a case in which the cost is prioritized, “subparts_a” which is the identical functional part is displayed to be specified. Specifically, “subparts_a” is displayed in bold. “subparts_a” which is the identical functional part is displayed to be specified.

Further, in this display example, for “subparts_a”, information related to the degree of recommendation, the failure probability, and the work time is displayed in the same manner as described above. Therefore, the person to be notified knows the information related to “subparts_a”.

Further, in FIG. 9B, as represented by reference numeral 90, information related to “Assy A” which is an assembly including “subparts_a” is displayed. Specifically, as the information related to “Assy A”, information related to the degree of recommendation, the failure probability, and the work time is displayed in the same manner as described above.

Further, in FIG. 9B, information related to “subparts_b”, which is a part other than “subparts_a” included in “Assy A” which is an assembly, is also displayed.

Specifically, as the information related to “subparts_b”, information related to the degree of recommendation, the failure probability, and the work time is displayed.

In the present exemplary embodiment, in a case in which the CPU 11a outputs the information related to “subparts_a” which is the identical functional part specified as the replacement part, the CPU 11a also outputs the information related to “Assy A” which is an assembly.

Specifically, in a case in which the CPU 11a outputs the information related to “subparts_a” which is the identical functional part specified as the replacement part, the CPU 11a outputs information related to each of the parts constituting “Assy A” which is an assembly as the information related to related to “Assy A” which is an assembly.

Therefore, the display shown in FIG. 9B is performed.

In a case in which the display shown in FIG. 9B is performed, the person to be notified knows that the identical functional part is installed by the installation of a new assembly including the identical functional part from the assembly including the failed part, in addition to the replacement of the failed part with the identical functional part.

In addition, in a case in which the display shown in FIG. 9B is displayed, the person to be notified knows that “subparts_b”, which is a part different from the identical functional part, is replaced by the installation of the new assembly including the identical functional part from the assembly including the failed part.

In the display example shown in FIG. 9B, the person to be notified knows that the identical functional part which is a part replacing the failed part is “subparts_a” and that the replacement of the failed part with “subparts_a” is performed by the installation of “Assy A” which is a new assembly.

Further, in the display examples shown in FIGS. 9A and 9B, the person to be notified knows each of the parts replaced by the replacement of “Assy A” which is an assembly.

Furthermore, in the display examples shown in FIGS. 9A and 9B, the person to be notified knows the work time required for installing the assembly and the work time required for installing the parts constituting the assembly for each assembly and for each part.

### OTHERS

In the above description, a case in which the information related to the parts constituting the image forming apparatus 100 is displayed has been described as an example.

An apparatus for which information related to the parts is displayed is not limited to the image forming apparatus 100. For example, in the display of information related to parts provided in apparatuses other than the image forming apparatus 100, each of the above-described processes may also be performed.

Examples of other apparatuses include medical apparatuses, apparatuses for transporting automobiles and the like, air conditioning apparatuses, such as air conditioners, information processing-related apparatuses, such as computer apparatuses, and apparatuses generally used in daily life, such as home appliances.

### SUPPLEMENTARY NOTE

(((1)))
An information processing apparatus comprising:
a processor configured to:
   specify replacement parts that are installable in an apparatus in place of some of parts constituting the apparatus; and
   output one or more of information related to a form of the specified replacement part, information related to a weight of the specified replacement part, and information related to installation of the specified replacement part in the apparatus.
(((2)))
The information processing apparatus according to (((1))), wherein the processor is configured to:
output information related to a size of the replacement part as the information related to the form of the specified replacement part.
(((3)))
The information processing apparatus according to (((2))), wherein the processor is configured to:
output information related to dimensions of the replacement part as the information related to the size of the replacement part.
(((4)))
The information processing apparatus according to (((1))), wherein the processor is configured to:
output information related to an exterior material that covers the replacement part as the information related to the form of the specified replacement part.
(((5)))
The information processing apparatus according to (((4))), wherein the processor is configured to:
output information indicating whether the exterior material has a bag shape or a box shape as the information related to the exterior material.
(((6)))
The information processing apparatus according to (((1))), wherein the processor is configured to:
output information related to ease of transportation of the replacement part to the apparatus as the information related to the installation of the specified replacement part in the apparatus.
(((7)))
The information processing apparatus according to (((1))), wherein the processor is configured to:
output information related to a work time required for installing the replacement part in the apparatus as the information related to the installation of the specified replacement part in the apparatus.
(((8)))
The information processing apparatus according to any one of (((1))) to (((7))), wherein the processor is configured to:
output information that is related to the specified replacement part and that is related to the replacement part covered with an exterior material in a case in which one or more of the information items are output.
(((9)))
The information processing apparatus according to any one of (((1))) to (((7))), wherein the processor is configured to:
output information that is related to the specified replacement part and that is related to the replacement part not covered with an exterior material in a case in which one or more of the information items are output.
(((10)))
The information processing apparatus according to any one of (((1))) to (((9))), wherein the processor is configured to:
further output an image of the specified replacement part.
(((11)))
The information processing apparatus according to (((10))), wherein the processor is configured to:
in a case in which there are a plurality of the specified replacement parts and an image of each of the plurality of replacement parts is included in one screen and output, unify scales of the replacement parts.
(((12)))
An information processing apparatus comprising:
a processor configured to:
   acquire priority information that is information related to a priority of a user; and
   specify replacement parts that are parts newly installed in an apparatus in place of some of parts constituting the apparatus on the basis of the priority specified by the acquired priority information.
(((13)))
The information processing apparatus according to (((12))), wherein the processor is configured to:
in a case in which information indicating that time is prioritized over a cost is acquired as the priority information, specify, as the replacement part, an assembly that is assembled on the basis of a plurality of parts including a functional part that is a part fulfilling functions of some parts and parts other than the functional part.
(((14)))
The information processing apparatus according to (((13))), wherein the processor is configured to:
in a case in which information indicating that the cost is prioritized over the time is acquired as the priority information, specify the functional part as the replacement part instead of the assembly.
(((15)))
The information processing apparatus according to (((13))), wherein the processor is configured to:
output information related to the specified assembly and also output information related to each of parts constituting the assembly.
(((16)))
The information processing apparatus according to (((14))), wherein the processor is configured to:
output information related to the functional part specified as the replacement part and also output information related to the assembly.
(((17)))
The information processing apparatus according to (((16))), wherein the processor is configured to:
also output information related to each of parts constituting the assembly.
(((18)))
A program that causes a computer to implement:
a function of specifying replacement parts that are installable in an apparatus in place of some of parts constituting the apparatus; and
a function of outputting one or more of information related to a form of the specified replacement part, information related to a weight of the specified replacement part, and information related to installation of the specified replacement part in the apparatus.
(((19)))
A program that causes a computer to implement:
a function of acquiring priority information that is information related to a priority of a user; and
a function of specifying replacement parts that are parts newly installed in an apparatus in place of some of parts constituting the apparatus on the basis of the priority specified by the acquired priority information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
specify replacement parts that are installable in an apparatus in place of some of parts constituting the apparatus; and
output one or more of information related to a form of the specified replacement part, information related to a weight of the specified replacement part, and information related to installation of the specified replacement part in the apparatus.

2. The information processing apparatus according to claim 1, wherein the processor is configured to:
output information related to a size of the replacement part as the information related to the form of the specified replacement part.

3. The information processing apparatus according to claim 2, wherein the processor is configured to:
output information related to dimensions of the replacement part as the information related to the size of the replacement part.

4. The information processing apparatus according to claim 1, wherein the processor is configured to:
output information related to an exterior material that covers the replacement part as the information related to the form of the specified replacement part.

5. The information processing apparatus according to claim 4, wherein the processor is configured to:
output information indicating whether the exterior material has a bag shape or a box shape as the information related to the exterior material.

6. The information processing apparatus according to claim 1, wherein the processor is configured to:
output information related to ease of transportation of the replacement part to the apparatus as the information related to the installation of the specified replacement part in the apparatus.

7. The information processing apparatus according to claim 1, wherein the processor is configured to:
output information related to a work time required for installing the replacement part in the apparatus as the information related to the installation of the specified replacement part in the apparatus.

8. The information processing apparatus according to claim 1, wherein the processor is configured to:
output information that is related to the specified replacement part and that is related to the replacement part covered with an exterior material in a case in which one or more of the information items are output.

9. The information processing apparatus according to claim 1, wherein the processor is configured to:
output information that is related to the specified replacement part and that is related to the replacement part not covered with an exterior material in a case in which one or more of the information items are output.

10. The information processing apparatus according to claim 1, wherein the processor is configured to:
further output an image of the specified replacement part.

11. The information processing apparatus according to claim 10, wherein the processor is configured to:
in a case in which there are a plurality of the specified replacement parts and an image of each of the plurality of replacement parts is included in one screen and output, unify scales of the replacement parts.

12. An information processing apparatus comprising:
a processor configured to:
acquire priority information that is information related to a priority of a user; and
specify replacement parts that are parts newly installed in an apparatus in place of some of parts constituting the apparatus on the basis of the priority specified by the acquired priority information.

13. The information processing apparatus according to claim 12, wherein the processor is configured to:
in a case in which information indicating that time is prioritized over a cost is acquired as the priority information, specify, as the replacement part, an assembly that is assembled on the basis of a plurality of parts including a functional part that is a part fulfilling functions of some parts and parts other than the functional part.

14. The information processing apparatus according to claim 13, wherein the processor is configured to:
in a case in which information indicating that the cost is prioritized over the time is acquired as the priority information, specify the functional part as the replacement part instead of the assembly.

15. The information processing apparatus according to claim 13, wherein the processor is configured to:
output information related to the specified assembly and also output information related to each of parts constituting the assembly.

16. The information processing apparatus according to claim 14, wherein the processor is configured to:
output information related to the functional part specified as the replacement part and also output information related to the assembly.

17. The information processing apparatus according to claim 16, wherein the processor is configured to:
also output information related to each of parts constituting the assembly.

18. A non-transitory computer readable medium storing a program that causes a computer to implement:
a function of specifying replacement parts that are installable in an apparatus in place of some of parts constituting the apparatus; and
a function of outputting one or more of information related to a form of the specified replacement part, information related to a weight of the specified replacement part, and information related to installation of the specified replacement part in the apparatus.

19. A non-transitory computer readable medium storing a program that causes a computer to implement:
a function of acquiring priority information that is information related to a priority of a user; and
a function of specifying replacement parts that are parts newly installed in an apparatus in place of some of parts constituting the apparatus on the basis of the priority specified by the acquired priority information.
